(19) United States
(12) Patent Application Publication
(10) Pub. No.: US 2008/0209805 A1
(43) Pub. Date: Sep. 4, 2008

(54) Wall Planted with Vegetation and Constituent Elements

(75) Inventors: Jean Francois Daures, Verdun (FR); Claude Maurette, Lombard (FR)

Correspondence Address: YOUNG & THOMPSON, 209 Madison Street, Suite 500, ALEXANDRIA, VA, 22314, US

(73) Assignee: GREENWALL SAS, ALES CEDEX (FR)

(21) Appl. No.: 11/997,755

(22) PCT Filed: Jul. 27, 2006
(86) PCT No.: PCT/FR2006/001833

§ 371 Date: May 15, 2008

(30) Foreign Application Priority Data
Aug. 2, 2005 (FR) 0508301

(51) Int. Cl. A01G 9/02

(52) U.S. Cl. 47/66.7; 47/82

(57) ABSTRACT

The inventive vegetated wall includes supports arranged on a wall to be covered or at a small distance therefrom, an integrated irrigation system and a plurality of open mesh baskets which are provided with a vegetable culture substrate arranged therein and which are removably associated with the supports in such a way that the baskets are enabled to be displaceable.

This invention relates to a wall planted with vegetation that is designed to be placed on a structural wall so as to constitute at the same time a decorative element, a heat insulation element, and a sound-damping element, as well as a process for creating such a wall.

The closest prior art of the invention consists of the French Patent No. 96.04526 (BLANC, Patrick) and the patent PCT/EP88/00047 (MIELKE).

The BLANC patent describes a device for cultivating plants without soil on an essentially vertical surface that comprises, applied against a support wall, for example, a wall, a layer of a water-retaining, rot-proof material, and inclined walls that are placed one on top of the other and that provide openings that are suitable for the installation of plants. The technology of the BLANC patent exhibits the drawback that the plant can be installed and cultivated on the site only after the device is mounted on the wall.

The MIELKE patent describes elements for a wall to be planted with vegetation that consist of small crates with a front opening that are juxtaposed and that are placed one on top of the other and whose bottom and lateral walls are not equipped with openings other than those that are necessary for the passage of nutrient liquids, in particular water, and that receive a substrate in which the plants will become rooted. The application of this patent is limited to the installation of sod on the walls. One of the drawbacks of this MIELKE patent is the front opening of the small crates that subjects the plants and the substrates to onslaughts of bad weather.

In the earlier prior art cited, the cultivation of the plants is provided after installation of the constituent elements on the wall to be covered, which is sometimes difficult when it is necessary to carry out these operations over great heights.

In addition, this operating procedure does not provide a solution to the concomitant risk of cultivating plants that may succeed or be a failure, in which case the wall remains bare or with some areas empty of vegetation.

Further, in these known techniques, it is not possible, without repeated interventions on the site and therefore a large additional expense, to vary the grades of plants and/or to mix them when they have different cultivation cycles.

This invention aims at eliminating these drawbacks by producing a wall element that can be used to carry out a pre-cultivation of the vegetation and that makes it possible to install a large pallet of various plantings that are perfectly developed at the moment when they are placed on the wall, in particular thanks to the use of removable elements that it is easy to attach and to remove.

The invention makes it possible to produce a support wall planted with vegetation of new functionality, for example by the use of fragrant and/or depolluting plants.

The invention makes it possible to produce a wall covering that can be perfectly suited to the climatology of the geographic zone where it should be produced since according to the invention, the plantings can be selected and combined with one another. It is also very easy to renew the vegetative covering with the passing seasons.

In addition, the invention makes it possible to produce a wall covering that is a heat insulator and also, because it obeys the acoustic law of mass/spring/mass and it offers a non-reflective absorbent surface on the outside, a wall covering that is a sound-damping agent.

For this purpose, the wall planted with vegetation according to the invention, designed to equip a structural wall or the like, comprises one or more supports, which are attached to the wall or are at a short distance from the latter to provide an air space, and an integrated irrigation system, and it also comprises a number of open-mesh baskets in which a substrate for cultivating vegetation is housed, whereby said baskets are combined with said supports in a removable manner so that the baskets can be removed.

According to the invention, the supports receive a number of baskets that are juxtaposed and placed one on top of the other in multiple rows. These baskets are baskets of parallelepipedic shape that are closed over all their surfaces and with open meshes in which a substrate for cultivating the plant or plants is housed.

This arrangement of the invention makes it possible, on the one hand, to cultivate the plants before it is put on the wall, which makes it possible to select the baskets in which the cultivation is successful.

This arrangement of the invention also makes it possible to produce combinations of different varieties, regardless of the duration of their cultivation cycle.

This arrangement of the invention also makes it possible to replace the plants easily, for example when their floral cycle has ended.

Another object of the invention is a process for the production of a wall planted with vegetation that consists in installing a number of open-mesh baskets that contain a substrate on which vegetation was previously cultivated on juxtaposed supports that cover the surface of a wall to be planted with vegetation and that are equipped with an integrated irrigation system. The device according to the invention, as it has just been described, advantageously can be used for the production of this process.

Other advantages and characteristics of the invention will emerge from reading the description below of a production of the invention given by way of non-limiting example and illustrated by the accompanying drawings, in which:

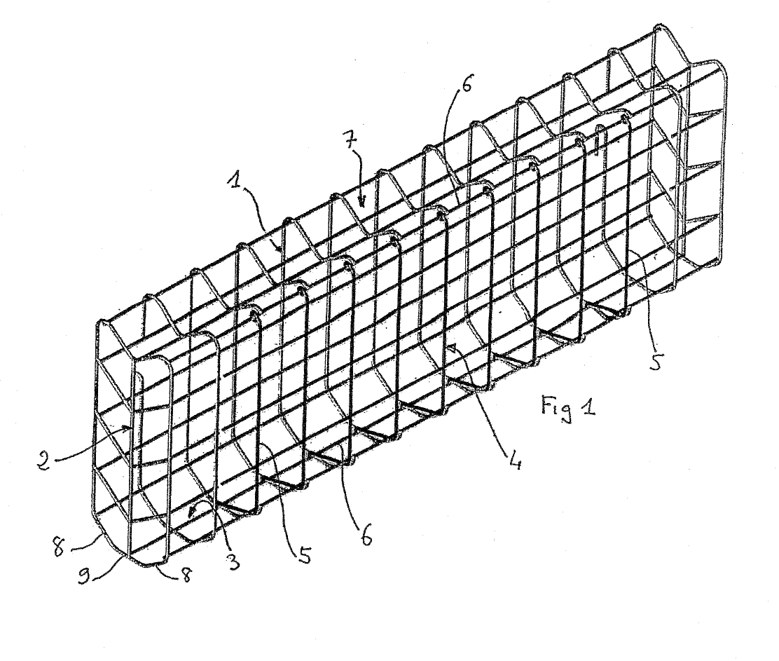

FIG. 1 is a view of a basket according to the invention that is closed;

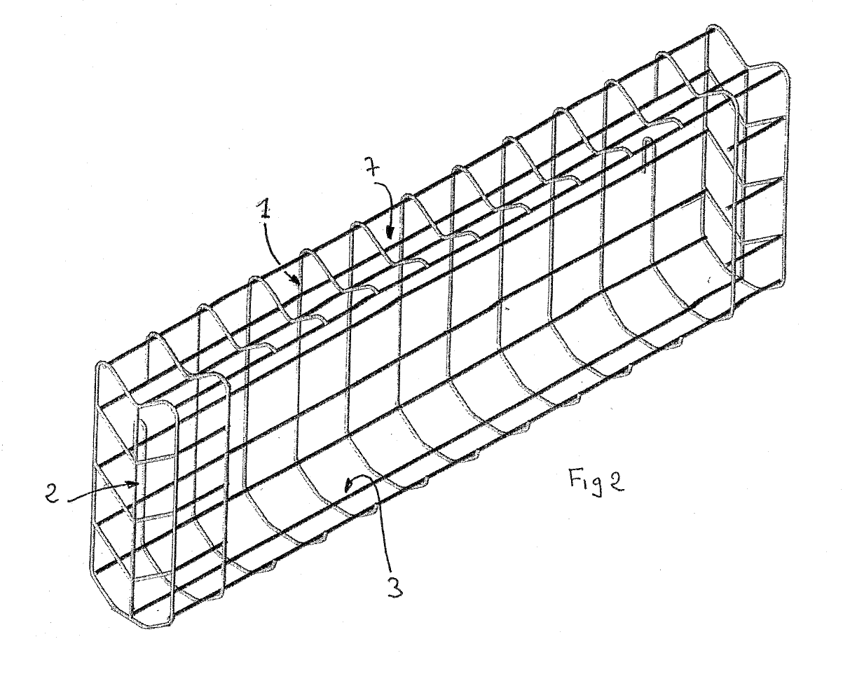

FIG. 2 is a view of a basket according to the invention that is open;

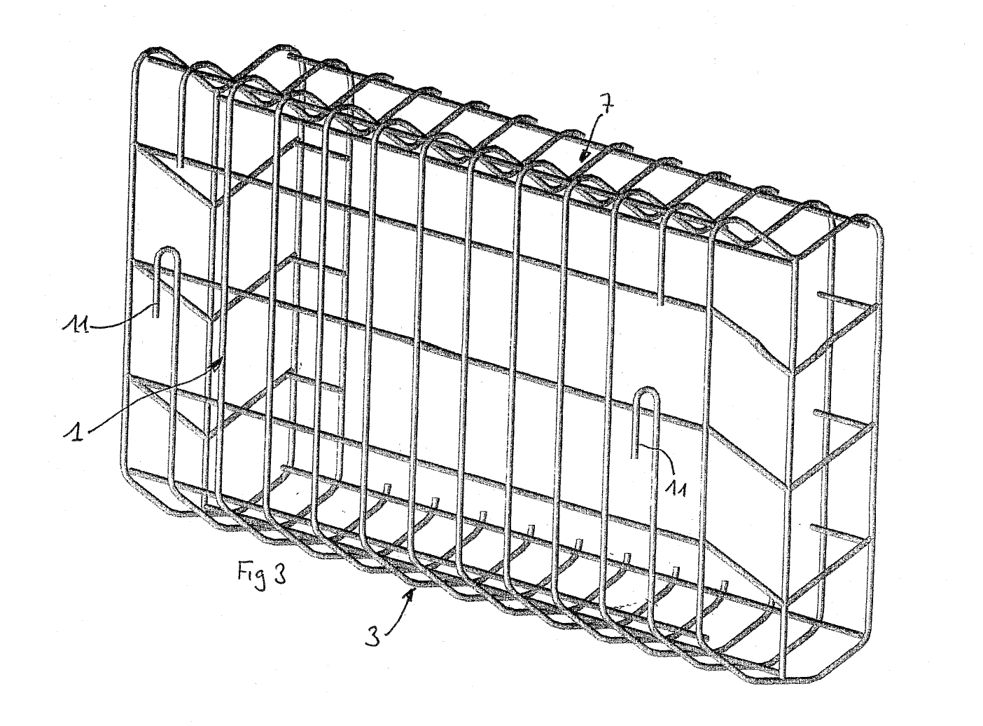

FIG. 3 is a rear view of the basket according to the invention;

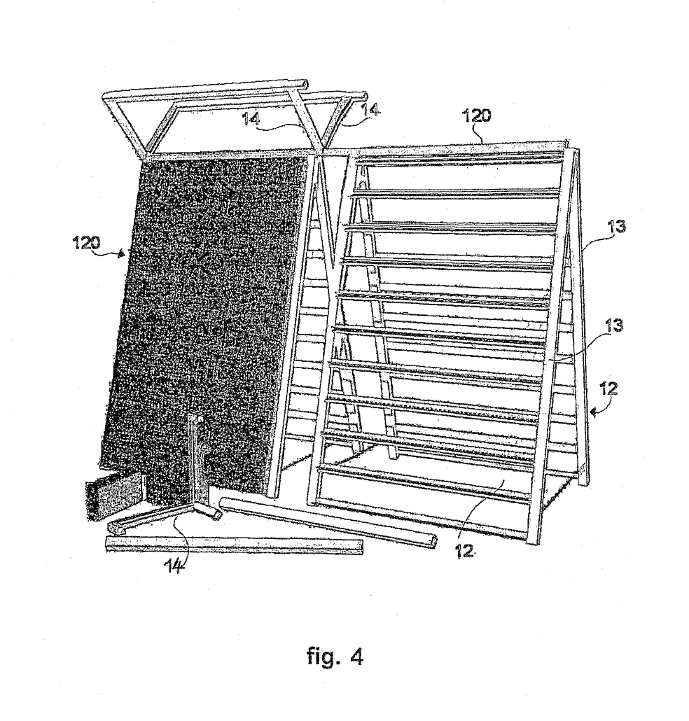

FIG. 4 is a view of a support stand for cultivating plants in the baskets before they are put in place.

The invention relates to a wall planted with vegetation that is designed to be placed on a structural wall or any other vertical or inclined structure.

To simplify the drawings, the wall has not been shown.

A support, not shown, made of one or more juxtaposed elements is placed on the vertical structure of the wall. The support or supports advantageously can be placed at a certain distance from the wall with a spacing that provides an air space.

The support consists of a preferably plane structure that can consist of a rigid metallic framework, a netting, or a support made of wood, terra cotta or synthetic material.

The support is advantageously provided with means for attachment by removable hanging of the baskets of any known type.

The basket according to the invention consists of an open-mesh metallic framework that consists of metallic wires that are treated to be resistant to corrosion, for example plasticized or galvanized and welded to one another, whereby some of these wires are horizontal and the others vertical.

Preferably, each basket has a parallelepipedic shape with a stationary rear surface 1, lateral surfaces 2, and upper surfaces 7 and lower surfaces 3 and a front door 4 in the front surface (FIG. 1) to allow the installation of the substrate and the plants.

For this purpose, the door 4 is articulated in its top part or in its bottom part and is equipped with means for attachment of the side that is opposite to the articulation.

Advantageously, the articulation of the door consists of the loop conformation of at least two of the vertical wires 5 of the door that clamp one of the horizontal wires 6 of the basket.

The means for locking the door consists of shaping the ends of at least two of the vertical wires 5 that fit onto one of the horizontal wires 6 of the basket in the form of hooks.

The dimensions of the baskets can be variable as appropriate to the figures, for example 200 millimeters in length to 200 millimeters in height and 85 millimeters in width.

The length can be a multiple of 200 millimeters, for example 400 or 600 millimeters.

According to an advantageous characteristic of the invention, the hoses for supply of nutrient liquid (water and/or fertilizer) from the irrigation system pass freely between the baskets. It therefore is not necessary to modify the irrigation circuit when it is desired to install a basket on the support or to withdraw it.

According to a preferred embodiment of the invention, the transversal upper surface 7 of the basket is recessed to allow the perforated hoses for supplying the substrate of the plants with nutrient liquid to pass through.

The lower transversal surface 3 of the basket is shaped with truncated ends with two inclined portions 8, each of its constituent wires inclined toward the longitudinal median axis and a horizontal median part 9 between the portions 8 in which the wires are horizontal.

This arrangement allows, at the same time, the baskets to be fit into place on one another with an attachment to one another and the perforated hose for supplying nutrient liquid from a programmable central distribution unit, not shown, to pass through freely. The baskets are juxtaposed and placed one on top of the other in multiple rows.

It goes without saying that without exceeding the scope of the invention, the vertical lateral surfaces 2 of the baskets can also, for one of them, be shaped with projecting ends, and, for the other, be recessed, so as to obtain a lateral locking effect of the baskets between one another.

In the embodiment of the basket (FIG. 3), the rear surface 1 of the basket is equipped with two removable attachment hooks 11 on the support. These two hooks 11 are obtained from the production by isolating and folding two vertical parallel wires that constitute the basket, one from each side of the latter. It goes without saying that any other removable hanging means may be suitable.

The basket can also be produced by folding and/or winding a strip of netting that is plasticized or galvanized or treated with an anti-corrosion agent in any known manner around the substrate.

The basket can also be made of a synthetic material with openings of the open-mesh type or of fabrics of the same type or any other material.

Prior to the cultivation of the plants, the basket is filled by a substrate that is preferably of vegetative origin with a strong water retention and restoration capability. The plants are then allowed to develop enough to obtain a good vegetative covering.

This pre-cultivation is carried out flat on the ground or in a vertical or essentially vertical position to acclimate the plant. Preferably, the pre-cultivation of the vegetation is conducted in baskets installed on a support reproducing the conditions of a wall such as a stand that exhibits at least one inclined support wall.

For this purpose, according to the invention, a cultivation support has been designed; this cultivation support is shown in FIG. 4. It consists of a stand 120 that has at least one and preferably two inclined walls 12 that are articulated at their top. Each of the walls 12 consists of a rigid netting that is attached to a frame 13 or crosspieces. The two frames are joined at their top by an articulation. Above the articulation are mounted supports 14 for the hoses for supplying nutrient liquid.

It is then possible to use this stand for the transport of baskets that contain the developed vegetation up to the site where they are to be installed.

Then, the hanging of the baskets on the wall supports is initiated by being careful to place the hoses for irrigation in the hollow furrow provided on the upper surface of the baskets.

The shaping of the wall planted with vegetation starting from individualized modules of the open-mesh basket type has many advantages.

It allows the cultivation of the plants prior to placing baskets on the support or supports and, if necessary, in various sites based on the climate, the season and/or the specialization of the horticulturists responsible for the cultivation.

The basket shape facilitates the transport from the cultivation sites to the installation locations.

1. Wall planted with vegetation that comprises supports that are placed on or at a short distance from a wall to be covered and an integrated irrigation system, characterized in that it comprises a number of open-mesh baskets in which a substrate for cultivating vegetation is housed, whereby said baskets are combined with said supports in a removable manner, such that the baskets can be removed.

2. Wall planted with vegetation according to claim 1, wherein the baskets are juxtaposed and placed one on top of the other in multiple rows.

3. Wall planted with vegetation according to claim 1, wherein each basket has a parallelepipedic shape with a stationary rear surface (1), lateral surfaces (2) of the upper surfaces (7) and lower surfaces (3) and a front door (4) for allowing the installation of the substrate of the plants.

4. Wall planted with vegetation according to claim 1, wherein the hoses for supplying nutrient liquid from the irrigation system pass freely between the baskets.

5. Wall planted with vegetation according to claim 1, wherein each basket comprises an upper surface (7) that is recessed to allow the hose for supplying nutrient liquid to pass through.

6. Wall planted with vegetation according to claim 1, wherein the lower surface of the basket is shaped with a truncated end with two portions (8) that are inclined toward the longitudinal median axis and a horizontal median part (9).

7. Wall planted with vegetation according to claim 1, wherein each basket is put together by interweaving horizontal and vertical metallic wires, providing open meshes.

8. Wall planted with vegetation according to claim 1, wherein each basket is equipped with a removable hanging device.

9. Process for the production of a wall planted with vegetation, wherein it consists in installing a number of open-mesh baskets—containing a substrate on which vegetation was previously cultivated—on juxtaposed supports that cover the surface of a wall to be planted with vegetation and that are equipped with an integrated irrigation system.

10. Process for the production of a wall planted with vegetation according to claim 9, wherein for the preliminary cultivation of the vegetation in the baskets, said baskets are installed on a stand that has at least one inclined support wall.

11. Process according to claim 9, wherein the stand is used for the transport of the baskets to the installation site.

12. Process for the production of a wall planted with vegetation, wherein it implements a device according to claim 1.

13. Wall planted with vegetation according to claim 2, wherein the hoses for supplying nutrient liquid from the irrigation system pass freely between the baskets.

14. Wall planted with vegetation according to claim 2, wherein the lower surface of the basket is shaped with a truncated end with two portions (8) that are inclined toward the longitudinal median axis and a horizontal median part (9).

15. Wall planted with vegetation according to claim 2, wherein each basket is put together by interweaving horizontal and vertical metallic wires, providing open meshes.

16. Wall planted with vegetation according to claim 2, wherein each basket is equipped with a removable hanging device.
